(19) United States
(12) Patent Application Publication
(10) Pub. No.: US 2007/0064559 A1
(43) Pub. Date: Mar. 22, 2007

(54) Disk apparatus

(75) Inventor: Kozo Wada, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/520,224

(22) Filed: Sep. 13, 2006

(30) Foreign Application Priority Data
Sep. 13, 2005 (JP) 2005-264911

(51) Int. Cl. G11B 20/10

(52) U.S. Cl. 369/47.28

(57) ABSTRACT

In a disk apparatus, an RF signal composed of an analog signal on information data read out from a DVD-RAM by an optical pickup is converted to a digital signal, a phase difference of the RF signal on the information data converted to the digital signal is detected to output a phase difference signal of the RF signal, a CAPA signal included in the phase difference signal of the RF signal on the information data is detected, a frequency/phase of the CAPA signal detected are compared with a frequency/phase of a reference clock signal, and a clock signal synchronized with the CAPA signal is generated according to the comparison results.

### BACKGROUND OF THE INVENTION

1. Field of the Invention

The present invention relates to a disk apparatus for reproducing information data stored in an optical disk such as a DVD (Digital Versatile Disc) and, more specifically, the invention relates to a disk apparatus which, using a simple circuit configuration, can generate a clock signal synchronized with the rotation speed of a DVD-RAM (DVD-Random Access Memory).

2. Description of the Related Art

Conventionally, when reproducing information data stored in a DVD-RAM, periodical wobbles in wobble-shaped grooves and lands formed in the data recording area of a DVD-RAM are retrieved by an optical pickup to thereby detect a wobble signal, and the clock signal of a PLL (Phase Locked Loop) circuit is synchronized with the wobble signal.

Now, FIG. 2 is a block diagram of the structure of a conventional disk apparatus. In FIG. 2, reference numeral 50 designates a disk apparatus, 51 an optical disk, 52 an optical pickup, 53 a spindle motor, 54 a motor drive IC (Integrated Circuit), and 55 a disk servo circuit, respectively. Also, 60 stands for a read channel block. The read channel block 60 is composed of an AGC (Automatic Gain Control) circuit 61, an AD (Analog-Digital) conversion circuit 62, a digital equalizer 63, and a binarization circuit 64. And, 70 designates a PLL block. The PLL block 70 is composed of a band pass filter 71, a wobble signal detect circuit 72, a frequency/phase compare circuit 73, a VCO (Voltage Controlled Oscillator) 74, and a clock control circuit 75. Also, 81 designates an AD conversion circuit, 82 a digital equalizer, 83 a phase difference detect circuit, 84 a low band pass filter, and 85 a CAPA (Complimentary Allocated Pit Address) signal detect circuit, respectively.

A wobble signal is read out from the grooves and lands of the optical disk 51 by the optical pickup 52. The thus read-out wobble signal composed of an analog signal is converted to a digital signal by the AD conversion circuit 81. The low band frequency component and high band frequency component of the wobble signal converted to the digital signal are cut off by the band pass filter 71. The wobble signal having passed through the band pass filter 71 is detected by the wobble-signal detect circuit 72. The frequency/phase of the wobble signal are compared with the frequency/phase of a reference clock signal by the frequency/phase compare circuit 73. A clock signal is oscillated by the VCO 72 according to a voltage based on the comparison results of the frequencies/phases, and the clock signal oscillated by the VCO 72 is controlled by the clock control circuit 75, thereby generating a clock signal synchronized with the wobble signal read out from the optical disk 51. However, to synchronize the clock signal of the PLL circuit with the wobble signal, there is necessary a wobble signal detect circuit for detecting a wobble signal, which makes it difficult to reduce the production cost of the disk apparatus.

As a background art, there is known a disk apparatus in which a slice level for slicing a signal of the CAPA part of an RFDIF signal generated from an RF signal read out by an optical pickup is set, the CAPA part is detected and is further binarized, and the slice level is switched according to the read-out state of the CAPA part (for example, see JP-A-2004-355774).

Also, there is also known a disk apparatus which generates a clock signal according to a phase difference between wobble and clock signals, outputs the clock signal of a PLL circuit in synchronization with the wobble signal, detects a period in which the address information of the wobble signal is contained, and thereby locks the clock signal of the PLL circuit (for example, see JP-A-2004-253057).

Further, there is known a disk apparatus which presets the leading frame previous notice signal of a preamble part, supplies the bit synchronizing signal of the preamble part to a PLL circuit to input a clock signal into a second counter, divides the frequency of the carry output of the second counter to input the frequency divided carry output into a first counter, and takes out the carry output of the first counter as a synchronization signal showing the position of an effective data (for example, see JP-A-61-271669).

### SUMMARY OF THE INVENTION

However, in the first one of the three conventional techniques described above, by setting a slice level for slicing the signal of the CAPA part of the RFDIF signal generated from the RF signal read out by the optical pickup, the CAPA part is detected and is further binarized, and the slice level can be switched according to the read-out state of the CAPA part. That is, the object of the first conventional technique is that, when the wobble signal is detected to be great in part due to vibrations or the like when reproducing the optical disk, the slice level for slicing the CAPA part of the RFDIF signal is switched to thereby detect the CAPA. In other words, this technique does not aim at generating a clock signal in synchronization with the rotation speed of the optical disk.

Also, in the second conventional technique, a clock signal is generated according to a phase difference between the wobble and clock signals, the clock signal of the PLL circuit is outputted in synchronization with the wobble signal, and the period containing the address information of the wobble signal is detected to thereby be able to lock the clock signal of the PLL circuit. That is, the second conventional technique aims at synchronizing the clock signal of the PLL circuit with the wobble signal but does not aim at solving the above-mentioned problem.

Further, in the third conventional technique, the leading frame previous notice signal of the preamble part is preset in the first counter, the bit synchronizing signal of the preamble part is supplied to the PLL circuit to input the clock signal into the second counter, the carry output of the second counter is frequency divided and is inputted into the first counter, and the carry output of the first counter can be taken out as the synchronization signal showing the position of the effective data. In other words, this technique aims to detect the leading frame previous notice signal of the preamble part of the digital data of the video disk to thereby generate the synchronization signal and, when the leading synchronization signal of the frame cannot be obtained, aims to generate a synchronization signal from the first frame. Thus, this is not a technique which generates a clock signal in synchronization with the rotation speed of the optical disk.

The present invention is made in view of the above-mentioned problem found in the background art and thus the object of the invention is to provide a disk apparatus which, while eliminating the wobble signal detect circuit for detecting the wobble signal and eliminating the use of the wobble signal, by using a simple circuit configuration, can synchronize the clock signal of the PLL circuit with the rotation speed of a DVD-RAM.

According to the invention, there is provided a disk apparatus for generating the clock signal of a PLL circuit synchronized with the rotation speed of an optical disk to reproduce information data recorded in the optical disk, the disk apparatus comprising: AD conversion means for converting an RF signal composed of an analog signal on the information data read out from a DVD-RAM by an optical pickup to a digital signal; phase difference detect means for correcting the frequency characteristics of the RF signal on the information data converted to the digital signal by the AD conversion means to detect the phase difference of the RF signal on the information data, and for outputting the phase difference signal of the RF signal; CAPA signal detect means for detecting a CAPA signal included in the phase difference signal of the RF signal on the information data detected by the phase difference detect means; frequency/phase compare means for comparing the frequency/phase of the CAPA signal detected by the CAPA signal detect means with the frequency/phase of a given reference clock signal; and, clock signal generate means for generating a clock signal synchronized with the CAPA signal according to the comparison results obtained by the frequency/phase compare means.

The phase difference detect means may be preferably structured such that it corrects the frequency characteristic of the RF signal on the information data converted to the digital signal by the AD conversion means, detects the phase difference of the RF signal on the information data and outputs the phase difference signal of the RF signal.

The CAPA signal detect means may be preferably structured such that it cuts off a given high band frequency component of the phase difference signal of the RF signal on the information data detected by the phase difference detect means and detects the CAPA signal included in the phase difference signal of the RF signal on the information data.

The clock signal generate means may be preferably structured such that it generates a clock signal synchronized with the CAPA signal according to a voltage set based on the comparison result of the frequency/phase of the CAPA signal compared by the frequency/phase compare means.

Use of these means can omit the wobble signal detect circuit for detecting the wobble signal and also can eliminate the use of the wobble signal. Thus, according to the invention, using a simple circuit configuration, the clock signal of the PLL circuit can be synchronized with the rotation speed of a DVD-RAM.

According to a disk apparatus of the invention, an RF signal composed of an analog signal on information data read out from a DVD-RAM by an optical pickup is converted to a digital signal, the frequency characteristic of the RF signal on the information data converted to the digital signal is corrected to detect the phase difference of the RF signal on the information data and the phase difference signal of the RF signal is outputted, a given high band frequency component of the phase difference signal of the RF signal on the information data detected is cut off to detect the CAPA signal included in the phase difference signal of the RF signal on the information data, the frequency/phase of the CAPA signal detected are compared with the frequency/phase of a reference clock signal, and a clock signal synchronized with the CAPA signal is generated according to a voltage based on the comparison results of the frequency/phase of the CAPA signal compared. Thus, according to this structure, while omitting the wobble signal detect circuit for detecting a wobble signal and eliminating use of the wobble signal, there can be generated the clock signal of the PLL circuit in synchronization with the CAPA signal and thus the clock signal of the PLL circuit can be synchronized with the rotation speed of the DVD-RAM.

According to a disk apparatus of the invention, an RF signal composed of an analog signal on information data read out from a DVD-RAM by an optical pickup is converted to a digital signal, the phase difference of the RF signal on the information data converted to the digital signal is detected and the phase difference signal of the RF signal is outputted, the CAPA signal included in the phase difference signal of the RF signal on the information data detected is detected, the frequency/phase of the CAPA signal detected are compared with the frequency/phase of a reference clock signal, and a clock signal synchronized with the CAPA signal is generated according to the comparison results thereof. Thus, according to this structure, while omitting the wobble signal detect circuit for detecting a wobble signal and eliminating use of the wobble signal, there can be generated the clock signal of the PLL circuit in synchronization with the CAPA signal and the clock signal of the PLL circuit can be synchronized with the rotation speed of the DVD-RAM.

According to a disk apparatus of the invention, the frequency characteristics of an RF signal on the information data converted to a digital signal are corrected to detect the phase difference of the RF signal on the information data, and the phase difference signal of the RF signal is outputted. Thus, while correcting the frequency characteristics of the RF signal on the information data converted to the digital signal, the phase difference of the RF signal on the information data can be detected easily.

According to a disk apparatus of the invention, a given high band frequency component of the phase difference signal of the RF signal on the information data detected is cut off to thereby detect the CAPA signal included in the phase difference signal of the RF signal on the information data. Therefore, while cutting off the high band frequency component of the phase difference signal on the information data, the CAPA signal included in the phase difference signal of the RF signal on the information data can be detected easily.

According to a disk apparatus of the invention, since there can be generated a clock signal synchronized with the CAPA signal according to a voltage based on the comparison results of the frequency/phase of the CAPA signal, while omitting a wobble signal detect circuit for detecting a wobble signal and also eliminating use of the wobble signal, the clock signal of the PLL circuit synchronized with the CAPA signal can be generated.

### BRIEF DESCRIPTION OF THE DRAWINGS

FIG. 1 is a block diagram of the structure of a disk apparatus according to an embodiment of the invention; and

FIG. 2 is a block diagram of the structure of a conventional disk apparatus.

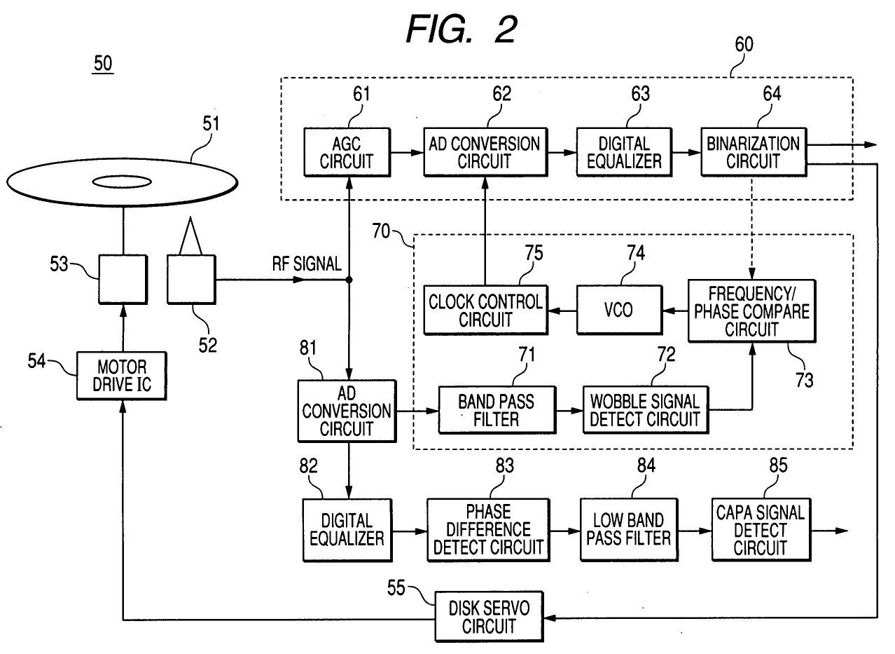

### DETAILED DESCRIPTION OF THE PREFFERED EMBODIMENTS

Now, description will be given below in detail of an embodiment of the invention with reference to the accompanying drawing.

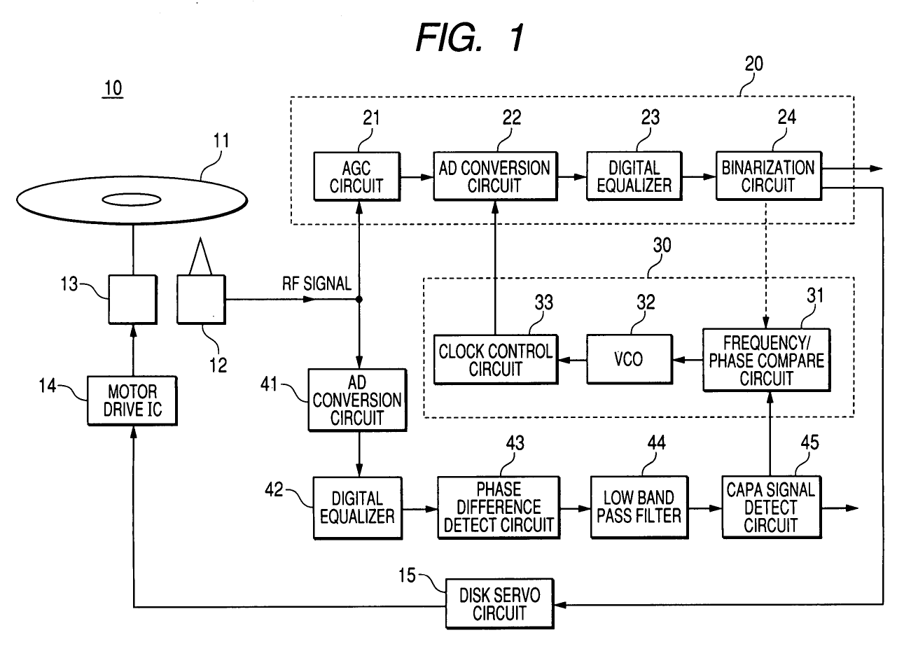

Firstly, description will be given below of the invention with reference to a block diagram of FIG. 1 showing the structure of a disk apparatus according to an embodiment of the invention.

A disk apparatus 10 comprises: an optical pickup 12 which radiates a laser beam on the recording surface of an optical disk 11 to detect the reflected light thereof and reads information data recorded on the optical disk 11; a spindle motor 13 for rotating the optical disk 11; a motor drive IC 14 for driving the spindle motor 13; a disc servo circuit 15 for servo controlling the motor drive IC; a read channel block 20 for processing an RF signal on the information data read from the optical disk 11 by the optical pickup 12; a PLL block 30 for generating a clock signal synchronized with the rotation speed of the optical disk 11; an AD conversion circuit 41 for converting the RF signal composed of an analog signal on the information data read out from the optical disk 11 by the optical pickup 12 to a digital signal; a digital equalizer 42 for correcting the frequency characteristics of the RF signal on the information data converted to the digital signal by the AD conversion circuit 41; a phase difference detect circuit 43 for detecting the phase difference of the RF signal on the information data with the frequency characteristics thereof corrected by the digital equalizer 42 and for outputting the phase difference signal of the RF signal; a low band pass filter 44 for cutting off a high band frequency component of the phase difference signal of the RF signal on the information data outputted from the phase difference detect circuit 43 and for permitting the passage of a given low band frequency component of the phase difference signal; and, a CAPA signal detect circuit 45 for detecting a CAPA signal included in the phase difference signal of the RF signal on the information data composed of the low band frequency component having passed the low band pass filter 44.

The read channel block 20 comprises an AGC circuit 21 for automatically adjusting the signal level of the RF signal on the information data read out from the optical disk 11 by the optical pickup 12; an AD conversion circuit 22 for converting the RF signal composed of an analog signal on the information data outputted from the AGC circuit 21 to a digital signal; a digital equalizer 23 for correcting the frequency characteristic of the RF signal on the information data converted to the digital signal by the AD conversion circuit 22; and a binarization circuit 24 for binarizing the RF signal on the information data with its frequency characteristic corrected by the digital equalizer 23 according to a given slice level.

Also, the PLL block 30 comprises a frequency/phase compare circuit 31 for comparing the frequency/phase of the CAPA signal detected by the CAPA signal detect circuit 45 with the frequency/phase of a reference clock signal; a VCO 32 for oscillating a clock signal synchronized with the CAPA signal according to a voltage based on the comparison results of the frequency/phase of the CAPA signal compared by the frequency/phase compare circuit 31; and a clock control circuit 33 for controlling the output of the clock signal oscillated by the VCO 32.

Now, description will be given below of the operation of the above-structured disk apparatus.

When reproduction of information data recorded in the optical disk 11 (DVD-RAM) is instructed by a key operation using a remote-control device (not shown), the motor drive IC 14 is driven by the disk servo circuit 15, the spindle motor 13 is rotated to thereby rotate the optical disk 11 at a given rotation speed, the information data recorded in the optical disk 11 is read by the optical pickup 12, and an RF signal on the information data read out from the optical disk 11 is transmitted to the AGC circuit 21 of the read channel block 20 and also to the AD conversion circuit 41.

In the case of the RF signal on the information data inputted into the read channel block 20, the amplitude level of the RF signal is automatically adjusted by the AGC circuit 21, the RF signal on the information data composed of an analog signal is converted to a digital signal by the AD conversion circuit 22, the frequency characteristic of the RF signal on the information data converted to the digital signal is corrected by the digital equalizer 23, the RF signal on the information data is binarized according to a given slice level by the binarization circuit 24, and thus binarized RF signal is transmitted to the disk servo circuit 15 as well as to a signal reproduce block (not shown) which is used to reproduce the information data and is composed of a demodulation/error correction circuit, a decoder, an encoder and the like.

On the other hand, in the case of the RF signal on the information data read out from the optical disk 11 and inputted to the AD conversion circuit 41, the RF signal composed of an analog signal on the information data is converted to a digital signal by the AD conversion circuit 41, the frequency characteristic of the RF signal on the information data converted to the digital signal is corrected by the digital equalizer 42, the phase difference of the RF signal on the information data is detected and the phase difference signal of the RF signal is outputted by the phase difference detect circuit 43, a given high band frequency component of the phase difference signal of the RF signal on the information data detected is cut off by the low band pass filter 44, a CAPA signal included in the phase difference signal of the RF signal on the information data composed of a given low band frequency component having passed through the low band pass filter 44 is detected by the CAPA signal detect circuit 45, and the CAPA signal is transmitted to the frequency/phase compare circuit 31 of the PLL block 30.

When the CAPA signal is inputted into the PLL block 30, the frequency/phase of the CAPA signal are compared with the frequency/phase of a clock signal by the frequency/phase compare circuit 31. The oscillation of the VCO 32 is controlled according to a voltage based on the comparison results of the frequency/phase of the CAPA signal compared by the frequency/phase compare circuit 31. A clock signal synchronized with the CAPA signal is generated by the VCO 32. A clock signal controlled by the clock control circuit 33 and synchronized with the CAPA signal is emitted to the AD conversion circuit 22 of the read channel block 20. The RF signal composed of an analog signal on the information data read out from the DVD-RAM by a clock signal synchronized with the rotation speed of the optical disk 11 is converted to a digital signal by the AD conversion circuit 22. The frequency characteristic of the RF signal on the information data converted to the digital signal by the AD conversion circuit 22 is corrected by the digital equalizer 23 to a given frequency characteristic. The RF signal on the information data with its frequency characteristic corrected to a given frequency characteristic by the digital equalizer 23 is binarized according a given slice level by the binarization circuit 24. The RF signal on the information data is decoded and is transmitted to a signal reproduce block (not shown) which is used to reproduce the information data and is composed of a demodulation/error correct circuit, a decoder, an encoder and the like, where the information data recorded on the optical disk 11 in the DVD-RAM is reproduced.

According to this structure, while eliminating a wobble signal detect circuit for detecting a Wobble signal and also eliminating use of the wobble signal, the clock signal of the PLL circuit synchronized with the CAPA signal can be generated; and also, while the clock signal of the PLL circuit is synchronized with the rotation speed of the optical disk in the DVD-RAM, the information data recorded on the optical disk can be reproduced.

Although description has been given heretofore in detail of the best mode for carrying out the invention, the invention is not limited to this but it goes without saying that other changes and improvements are also possible within the range of the normal knowledge of the persons who are skilled in the art.

What is claimed is:

1. A disk apparatus that generates a clock signal of a PLL circuit synchronized with a rotation speed of an optical disk to reproduce information data recorded in the optical disk, the disk apparatus comprising:
AD conversion means for converting an RF signal composed of an analog signal on the information data read out from a DVD-RAM by an optical pickup to a digital signal;
phase difference detect means for correcting the frequency characteristics of the RF signal on the information data converted to the digital signal by the AD conversion means to detect a phase difference of the RF signal on the information data, and for outputting a phase difference signal of the RF signal;
CAPA signal detect means for cutting off a given high band frequency component of the phase difference signal of the RF signal on the information data detected by the phase difference detect means to detect a CAPA signal included in the phase difference signal of the RF signal on the information data;
frequency/phase compare means for comparing a frequency/phase of the CAPA signal detected by the CAPA signal detect means with the frequency/phase of a given reference clock signal; and
clock signal generate means for generating a clock signal synchronized with the CAPA signal according to a comparison results of the frequency/phase of the CAPA signal compared by the frequency/phase compare means.

2. A disk apparatus that generates a clock signal of a PLL circuit synchronized with a rotation speed of an optical disk to reproduce information data recorded in the optical disk, the disk apparatus comprising:
AD conversion means for converting an RF signal composed of an analog signal on the information data read out from a DVD-RAM by an optical pickup to a digital signal;
phase difference detect means for detecting the RF signal on the information data converted to the digital signal by the AD conversion means, and for outputting a phase difference signal of the RF signal;
CAPA signal detect means for detecting a CAPA signal included in the phase difference signal of the RF signal on the information data;
frequency/phase compare means for comparing a frequency/phase of the CAPA signal detected by the CAPA signal detect means with a frequency/phase of a given reference clock signal; and
clock signal generate means for generating a clock signal synchronized with the CAPA signal according to a comparison results obtained by the frequency/phase compare means.

3. The disk apparatus as set forth in claim 2, wherein the phase difference detect means is phase difference detect means which corrects the frequency characteristic of the RF signal on the information data converted to the digital signal by the AD conversion means to detect the phase difference of the RF signal on the information data, and outputs the phase difference signal of the RF signal.

4. The disk apparatus as set forth in claim 2, wherein the CAPA signal detect means is CAPA signal detect means which cuts off a given high band frequency component of the phase difference signal of the RF signal on the information data detected by the phase difference detect means to detect the CAPA signal included in the phase difference signal of the RF signal on the information data.

5. The disk apparatus as set forth in claim 2, wherein the clock signal generate means is clock signal generate means which generates a clock signal synchronized with the CAPA signal according to a voltage set based on the comparison results of the frequency/phase of the CAPA signal compared by the frequency/phase compare means.
